(19) United States
(12) Patent Application Publication
(10) Pub. No.: US 2015/0291482 A1
(43) Pub. Date: Oct. 15, 2015

(54) Adjuvant Additive And Agrochemical Composition Including The Same

(71) Applicant: BASF SE, Ludwigshafen (DE)

(72) Inventors: Brian T. Betke, Riverview, MI (US); Kenneth L. Zack, Wyandotte, MI (US); David T. Durocher, Westland, MI (US); Laura L. Brasher, Clinton, MI (US); Christopher G. Utz, Farmington Hills, MI (US)

(21) Appl. No.: 14/430,404

(22) PCT Filed: Sep. 24, 2013
(86) PCT No.: PCT/US13/61276

§ 371 Date: Mar. 23, 2015

Related U.S. Application Data
(60) Provisional application No. 61/704,755, filed on Sep. 24, 2012.

(51) Int. Cl. C05G 3/06; A01N 25/30; A01N 57/20; C05C 3/00; C05G 3/02

(52) U.S. Cl. CPC C05G 3/06; C05C 3/00; C05G 3/02; A01N 57/20; A01N 25/30

(57) ABSTRACT

An adjuvant additive includes a first active substance, water, and a surfactant comprising a carboxylated alcohol alkoxylate of the general formula (I). An agrochemical composition includes the adjuvant additive and a second active substance in addition to the first active substance in the adjuvant additive.

### BACKGROUND OF THE INVENTION

The instant invention generally relates to an adjuvant additive and an agrochemical composition including the same. The adjuvant additive comprises a first active substance, water, and a surfactant comprising a carboxylated alcohol alkoxylate. The agrochemical composition includes a second active substance and the adjuvant additive. More specifically, the instant invention relates to an adjuvant additive and an agrochemical composition, each having increased storage stability and exhibiting decreased foam generation.

### DESCRIPTION OF THE RELATED ART

Adjuvants are generally known as substances which modify the effect of other chemical or pharmaceutical agents, i.e., active substances, while having few, if any, direct effects when administered alone. For this reason, adjuvants are frequently sought for inclusion with active substances in various compositions to enhance the intended effect of the active substances while reducing the amount of the active substance necessary to achieve a particular result.

Compositions comprising an active substance are useful for many applications. Specific examples of useful compositions are agrochemical compositions comprising a fertilizer active ingredient and/or a pesticide active ingredient as the active substance. Generally, the agrochemical compositions are applied to plants to deliver the active substance. However, there is a constant desire to improve uptake of the agrochemical compositions, and more specifically the active substance, and therefore reduce the number of applications and/or the amount of the active substance in the agrochemical compositions necessary to achieve a particular result, e.g., prevention of disease and/or infestation of the plants.

Further, performance and stability of agrochemical compositions comprising active substances is generally a concern, especially for the agrochemical compositions that include pesticide active ingredients and/or fertilizer active ingredients as the active substances. Generally, these types of agrochemical compositions are manufactured with higher amounts of active substances than are typically present in end use formulations of the same. These concentrated agrochemical compositions reduce shipping costs and make storage of the agrochemical compositions more efficient. End users need only dilute the concentrated agrochemical compositions with a solvent/diluent prior to use. However, storage stability issues, such as solubility of the concentrated agrochemical compositions, may become exacerbated due in part to the higher amounts of active substances and other components present in the agrochemical composition. In particular, pesticide and fertilizer active ingredients may be difficult to solubilize in various adjuvants also present in the agrochemical composition. Solubility problems result in poor storage stability of the concentrated agrochemical compositions and generally result in separation of the pesticide and fertilizer active ingredients from the concentrated agrochemical compositions. As is frequently the case, agitating the concentrated agrochemical compositions which have separated does not effectively resolve the solubility problem. Typically, agitation will not result in homogenization of the now separated concentrated agrochemical compositions, but will only temporarily disperse the components of the agrochemical composition before separation occurs again.

Separation of the concentrated agrochemical compositions is particularly troubling to end users because additional steps are required to homogenize the concentrated agrochemical compositions. Further, as described above, the resulting product is typically only homogenous for a temporary period of time and therefore has a narrow window of time which it may be applied before separation occurs again. Agrochemical compositions which are not homogenous at the time of application typically result in uneven application of the active substances present in the agrochemical compositions. Uneven application of the active substances typically requires the end users to conduct additional applications of these agrochemical compositions which increase the overall amount of the agrochemical compositions and the active substances expended to achieve a particular result, i.e., even application of the active substances.

Furthermore, even where an active substance is found to solubilize in a potential adjuvant, foam generation during preparation, handling, and use of the agrochemical compositions including the same also becomes a concern. Generally, excess foam generation can slow and add costly steps to preparation of these agrochemical compositions. Excess foam generation of agrochemical compositions during handling and use generally consumes time, adds additional steps, and may also result in uneven application of the active substances on plants.

Improvements in adjuvants which enhance the effect of active substances, improve storage stability, and inhibit foam generation could lead to improved efficiencies in manufacturing and application of agrochemical compositions by reducing production time and costs of the agrochemical compositions, improving ease of handling, and reducing overall application rates necessary to achieve a particular result, i.e., even application of the active substances.

### SUMMARY OF THE INVENTION AND ADVANTAGES

The instant invention provides an adjuvant additive for an agrochemical composition. The adjuvant additive comprises a first active substance, water, and a surfactant comprising a carboxylated alcohol alkoxylate of the general formula (I):

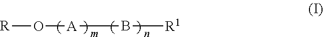

wherein R is hydrocarbon group having from 4 to 14 carbon atoms; R¹ is selected from the group of a hydrogen atom, an alkyl group, and an aryl group; each A is independently selected from an alkyleneoxy group having from 2 to 4 carbon atoms; m has a value of from 13 to 22; and each B is independently of the general formula (II):

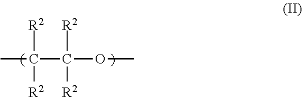

wherein each R² is independently selected from the group of a hydrogen atom, an alkyl group, and a salt of a carboxyl group, and n has a value of from 13 to 22, and wherein at least one R² is a salt of a carboxyl group.

The instant invention also provides an agrochemical composition for treating plants. The agrochemical composition comprises a second active substance and the adjuvant additive.

Both the adjuvant additive and the agrochemical composition of the instant invention exhibit improved storage stability as well as decreased foam generation during formation, handling, and use.

### DETAILED DESCRIPTION OF THE INVENTION

An adjuvant additive for agrochemical compositions and an agrochemical composition including the adjuvant additive are provided herein. The adjuvant additive includes a first active substance, water, and a surfactant comprising a carboxylated alcohol alkoxylate.

The first active substance typically includes, but is not limited to, biologically active substances, i.e., those substances having an adverse or beneficial effect on living matter. However, it is to be appreciated that the active substance is not limited to substances that are biologically active. The active substance may be provided in liquid or in solid particle form. Additionally, the active substance may be water-soluble, water-insoluble, partially water-soluble, oil-soluble, oil-insoluble, insoluble in acetone, insoluble in alcohol, insoluble in ether, and combinations thereof. In one embodiment, the active substance has a solubility in water of less than 80 g/100 mL at a temperature of 20° C. and is insoluble in acetone, alcohol, and ether. It is to be appreciated that the first active substance may include a combination of the active substances generally described above. In one embodiment, the first active substance may comprise a fertilizer active ingredient and may be used to treat plants by applying the first active substance onto the plants. In another embodiment, the first active substance may also be used as an adjuvant for agrochemical compositions including a pesticide active ingredient, stated differently, as the first active substance may function both as a fertilizer active ingredient and as an adjuvant for agrochemical composition including a pesticide active ingredient.

Examples of suitable fertilizer active ingredients include, but are not limited to, fertilizers including nitrogen, phosphorus, potassium, and combinations thereof. In one embodiment, the fertilizer active ingredient is a nitrogenous fertilizer including, but not limited to, ammonia solutions, ammonium salts, urea, thiourea, and combinations thereof. Examples of suitable ammonium salts include, but are not limited to, ammonium nitrate, ammonium sulfate, ammonium hydrogensulfate, ammonium chloride, ammonium acetate, ammonium formate, ammonium oxalate, ammonium carbonate, ammonium bicarbonate, ammonium thiosulfate, ammonium phosphate, ammonium hydrogendiphosphate, ammonium dihydrogenmonophosphate, ammonium sodium hydrogenphosphate, ammonium thiocyanate. In one embodiment, the first active substance is ammonium sulfate.

The first active substance is typically present in the adjuvant additive in an amount of greater than 10 but less than 30% by weight, alternatively from 15 to 29% by weight, alternatively from 15 to 20%, alternatively from 20 to 29% by weight, and alternatively from 24 to 28% by weight, based on the total weight of said adjuvant additive. In this regard, the adjuvant additive may include relatively high amounts of the first active substance as compared to formulations that are intended for use by an end user.

In one embodiment, the water in the adjuvant additive is tap water as understood in the art. In another embodiment, the water is hard water as understood in the art, i.e., water having high mineral content. In yet another embodiment, the water in the adjuvant additive is further defined as deionized water. As is understood in the art, deionized water is substantially free of ions. Water is typically present in the adjuvant additive in an amount from 10 to 60% by weight, alternatively from 20 to 50% by weight, and alternatively from 30 to 40% by weight, based on total weight of the adjuvant additive.

The adjuvant additive further includes a surfactant comprising a carboxylated alcohol alkoxylate having the general formula (I):

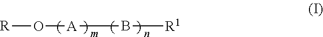

wherein R is hydrocarbon group having from 4 to 14 carbon atoms; R¹ is selected from the group of a hydrogen atom, an alkyl group, and an aryl group; each A is independently selected from an alkyleneoxy group having from 2 to 4 carbon atoms; m has a value of from 20 to 35; and each B is independently of the general formula (II):

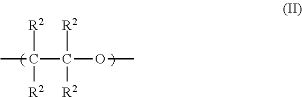

wherein each R² is independently selected from the group of a hydrogen atom, an alkyl group, and a salt of a carboxyl group, and n has a value of from 6 to 20, and wherein at least one R² is a salt of a carboxyl group. In one embodiment, the salt of the carboxyl group is further defined as a salt of a dicarboxylic group.

In another embodiment, the carboxylated alcohol alkoxylate is of the general formula (III):

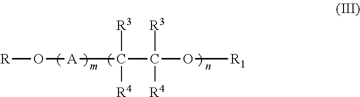

wherein R, R¹, A, m, and n are the same as described above; each R³ is independently selected from the group of a hydrogen atom and a methyl group; and each R⁴ is independently selected from the group of a hydrogen atom and a salt of a dicarboxylic group of the general formula (IV):

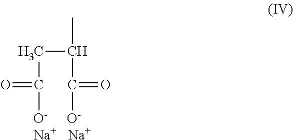

so long as at least one R⁴ is represented by a salt of a dicarboxylic group of the general formula (IV).

In one embodiment, m is from 20 to 30, alternatively from 20 to 24, and alternatively from 24 to 28. In another embodiment, n is from 15 to 19, alternatively from 6 to 15, and alternatively from 6 to 10. The value of m and n substantially control a number average molecular weight of the surfactant. In one embodiment, the carboxylated alcohol alkoxylate has a molecular weight of from 1,000 to 10,000 g/mol, alternatively from 1,000 to 5,000 g/mol, and alternatively from 1,000 to 3,000 g/mol.

A suitable examples of commercially available surfactants includes, but is not limited to, Plurafac® CS-1 which is commercially available from BASF Corp. The surfactant is typically present in an amount of from 1 to 20% by weight, alternatively from 5 to 15% by weight, and alternatively from 5 to 10% by weight, based on the total weight of the adjuvant additive.

Typically, the adjuvant additive remains homogenous at a temperature of 20° Celsius for a period of at least 3 days, alternatively 5 days, alternatively 10 days, alternatively 15 days, alternatively 20 days, alternatively 25 days, and alternatively 30 days. The terminology “homogenous”, as used herein in reference to the adjuvant additive, refers to a sufficiently low amount of visible particulates in the adjuvant additive and/or the absence of separation/stratification of the adjuvant additive. However, even when separation of the adjuvant additive may occur over extended periods of time, it has been found that a minimal amount of mixing and/or agitation of the adjuvant additive, will homogenize the adjuvant additive again for periods of time as described immediately above.

Typically, the adjuvant additive has a foam height of less than or equal to 20 mm measured at 10 seconds in accordance with F-106 Persistent Foaming Method. In another embodiment, the adjuvant additive has a foam height of less than or equal to 5 mm measured at 1 minute in accordance with F-106 Persistent Foaming Method. The F-106 Persistent Foaming Method is described additionally below in the Examples.

The adjuvant additive may also comprise additional components other than the first active substance, water, and the carboxylated alcohol alkoxylate. For example, the adjuvant additive may also include viscosity modifiers; surfactants; emulsifiers; antifreeze agents; antifoam agents; anti-settling agents; pH buffers, and combinations of the aforementioned additives. However, it is to be appreciated that these additional components are optional. Typically, the additional components are present in an amount of up to 2% by weight, alternatively 1% by weight, and alternatively 0.1% by weight, based on the total weight of the adjuvant additive. In one embodiment, the adjuvant additive further includes a viscosity modifier selected from the group of syrups of sugar and water or other viscous compositions including, but not limited to, high fructose corn syrup and honey. In this embodiment the viscosity modifier is present in the adjuvant additive in an amount of from 5 to 35% by weight, alternatively from 10 to 30% by weight, and alternatively from 15 to 25% by weight, based on the total weight of said adjuvant additive. In another embodiment, the adjuvant additive further includes a pH buffer. Suitable examples of pH buffers include, but are not limited to, NaOH, KOH, and NH₄OH.

In one embodiment, the adjuvant additive is buffered to a pH of from 6 to 10, alternatively from 7 to 9, and alternatively from 7.5 to 8.5. Without being bound to any particular theory, it is believed that buffering the adjuvant additive further increases stability and prevents separation of the adjuvant additive by inhibiting/delaying a shift in pH of the adjuvant additive over time. Additionally, even if separation of the adjuvant additive occurs after extended periods of time, it is believed that buffering the adjuvant additive which is separated reestablishes homogenization of the previously separated adjuvant additive.

It is to be appreciated that the adjuvant additive described herein has sufficiently acceptable stability and sufficiently prevents foaming, such that additional anti-settling or antifoam agents (described above as additional components that may be present) are not required in many circumstances. However, depending upon the particular active substance that is included in the adjuvant additive and/or agrochemical composition, the anti-settling and/or antifoam agents may be included in the adjuvant additive to further stabilize the adjuvant additive and/or the agrochemical composition.

Without being bound to any particular theory, it is believed that the surfactant increases performance of the active substances included in the adjuvant additive and the agrochemical composition described in greater detail below. More specifically, the surfactant increases residence time of the active substances on targets such as plants therefore increasing uptake of the active substances by the plants and improving the effectiveness/efficiency of each application of the adjuvant additive and/or the agrochemical composition. Additionally, it is believed that the surfactant increases the stability of the active substances included in the adjuvant additive and the agrochemical composition. More specifically, the surfactant inhibits/prevents separation of the active substances from either of the adjuvant additive or the agrochemical composition. With increased stability, the adjuvant additive and the agrochemical composition may be prepared including higher concentrations of the active substances than would typically be used by an end user while still ensuring even application of the active substances when used. As previously alluded to, the surfactant also inhibits and/or minimizes foam generation during formation, handling, and use of the adjuvant additive and/or the agrochemical composition therefore reducing time consuming and expensive defoaming steps.

Method of Preparing the Adjuvant Additive

A method of forming the adjuvant additive typically includes the step of combining the first active substance, water, the surfactant, and optionally the additional components in any order. In one embodiment, the first active substance is combined with water to form an intermediate and then the surfactant and optionally the additional components are added to this intermediate to form the adjuvant additive. In another embodiment, the method of forming the adjuvant additive further comprises the step of mixing the adjuvant additive after the step of combining. In yet another embodiment, the method of forming the adjuvant additive further comprises the step of pH buffering the adjuvant additive after the step of combining.

Agrochemical Composition

As introduced above, an agrochemical composition is also provided which includes a second active substance and the adjuvant additive. Typically, the second active substance is further defined as a pesticide active ingredient including, but not limited to, those active ingredients intended to target plants, animals (such as insects, rodents, etc.), bacteria, fungi, and the like. In one particular embodiment, the pesticide active ingredient is further defined as an herbicide active ingredient. Suitable examples of herbicide active ingredients include, but are not limited to, acetyl-CoA carboxylase inhibitors, acetolactate synthase inhibitors, amides, auxin herbicides, auxin transport inhibitors, carotinoid biosynthesis inhibitors, enolpyruvylshikimate-3-phosphate synthase inhibitors, glutamine synthetase inhibitors, lipid biosynthesis inhibitors, mitosis inhibitors, protoporphyrinogen IX oxidase inhibitors, photosynthesis inhibitors, synergists, growth substances, cell wall synthesis inhibitors, and combinations thereof. A suitable example of enolpyruvylshikimate-3-phosphate synthase inhibitors includes, but is not limited to, glyphosate.

Typically, the second active substance is present in an amount of from 1 to 65% by weight, alternatively from 1 to 50% by weight, alternatively from 1 to 35% by weight, and alternatively from 5 to 25% by weight, based on the total weight of the agrochemical composition.

The adjuvant additive is typically present in the agrochemical composition in an amount of from 1 to 20% by weight, alternatively from 1 to 15% by weight, alternatively from 1 to 10% by weight, and alternatively from 1 to 5% by weight, based on the total weight of the agrochemical composition. It is to be appreciated that the agrochemical composition may include relatively high amounts of the second active substance as compared to formulations that are intended for use by an end user. For example, when the second active substance is a pesticide active ingredient, the agrochemical composition having the second active substance present in the above amounts may be a suspension concentrate that is diluted with additional water to form water-based agrochemical compositions that are then applied by end users to plants.

Typically, the agrochemical composition is diluted with a solvent component to form end user formulations of the agrochemical composition. The solvent component may include water, including standard hard water as understood in the art, water-miscible liquids, oils, oil-miscible liquids, propylene glycol, tripropylene glycol, acetaldehyde, other known carriers, and combinations thereof. Typically, the solvent component comprises water. When included, the solvent component is typically present in the end user formulations of the agrochemical composition in an amount of from 10 to 99% by weight, alternatively from 50 to 99% by weight, alternatively from 80 to 99% by weight, alternatively from 85 to 95% by weight, based on the total weight of the agrochemical composition. Additionally, when the solvent component is included, end user formulations of the agrochemical composition typically include the second active substance in an amount of greater than 0 but less than 20% by weight, alternatively from 1 to 10% by weight, alternatively from 5 to 10% by weight, and alternatively from 6 to 8% by weight, based on the total weight of said end user formulation of the agrochemical composition. Furthermore, when the solvent component is included, the end user formulations of the agrochemical composition typically include the adjuvant additive in an amount of greater than 0 but less than 10% by weight, alternatively from 1 to 10% by weight, alternatively from 1 to 5% by weight, and alternatively from 1 to 3% by weight, based on the total weight of said end user formulation of the agrochemical composition.

As described above, the agrochemical composition further comprises the adjuvant additive including the surfactant. Due to the high amount of the first and/or second active substance that is typically included in the agrochemical composition, and due to the various solubilities of the first and/or second active substance, the adjuvant additive is included in the agrochemical composition for purposes of stabilizing the first and/or second active substance. The adjuvant additive is typically included in agrochemical compositions having high amounts of the first and/or second active substance; however, the adjuvant additive is also effective for stabilizing purposes in agrochemical compositions having low amounts of the first and/or second active substance. The agrochemical composition including the adjuvant additive has excellent storage stability as determined through stability tests that are described in detail below. The adjuvant additive that is included in the agrochemical composition of the instant invention also inhibits or limits foaming during formation, handling, and use of the agrochemical composition.

### Method of Preparing the Agrochemical Composition

One method of preparing an agrochemical composition in accordance with the instant invention comprises the step of combining the second active substance and the adjuvant additive to form the agrochemical composition. In another embodiment, the step of combining is further defined as combining the second active substance, the adjuvant additive, and a solvent component to form the agrochemical composition. In yet another embodiment, the step of combining is further defined as combining the adjuvant additive with a solvent component to form an intermediate and then combining this intermediate with the second active substance to form the agrochemical composition. In one embodiment, the method of preparing the agrochemical composition may further include the step of mixing the agrochemical composition after the step of combining.

### Examples

Adjuvant additives, including Inventive Example 1 and Comparative Examples 1-59, are prepared using various surfactants as set forth in Table 1 below, with all amounts listed as weight in grams. A first active substance is measured and combined with a predetermined amount of water to form a solution comprising the first active substance in an amount of 26% by weight, based on the total weight of the solution. A viscosity modifier/builder and then a surfactant are combined with the solution comprising the first active substance to form the various adjuvant additives.

TABLE 1

| | | | | 26% Solution of |
|---|---|---|---|---|
| | | Surfactant | Viscosity | First Active Sub- |
| Adjuvant | | Amount | Modifier | stance in Water |
| Additive | Surfactant | (g) | (g) | (g) |
| Inv. Ex. 1 | Surfactant 1 | 7 | 20.11 | 73.00 |
| Comp. Ex. 1 | Surfactant 2 | 7 | 19.99 | 73.01 |
| Comp. Ex. 2 | Surfactant 3 | 7.03 | 20.00 | 73.02 |
| Comp. Ex. 3 | Surfactant 4 | 7.01 | 20.04 | 73.02 |
| Comp. Ex. 4 | Surfactant 5 | 7 | 20.02 | 73.02 |
| Comp. Ex. 5 | Surfactant 6 | 7 | 20.02 | 73.02 |
| Comp. Ex. 6 | Surfactant 7 | 7.01 | 20.00 | 73.01 |
| Comp. Ex. 7 | Surfactant 8 | N/A* | — | — |
| Comp. Ex. 8 | Surfactant 9 | 7 | 20.04 | 73.03 |
| Comp. Ex. 9 | Surfactant 10 | 7.02 | 20.00 | 73 |
| Comp. Ex. 10 | Surfactant 11 | N/A* | — | — |
| Comp. Ex. 11 | Surfactant 12 | 7 | 20.03 | 73.02 |
| Comp. Ex. 12 | Surfactant 13 | 7 | 20.13 | 73.04 |
| Comp. Ex. 13 | Surfactant 14 | 7 | 20.02 | 73.01 |
| Comp. Ex. 14 | Surfactant 15 | 7 | 20.03 | 73.04 |
| Comp. Ex. 15 | Surfactant 16 | 7.01 | 20.01 | 73.02 |
| Comp. Ex. 16 | Surfactant 17 | 7.01 | 20.04 | 73.05 |
| Comp. Ex. 17 | Surfactant 18 | 7 | 20.17 | 73.03 |
| Comp. Ex. 18 | Surfactant 19 | 7.01 | 20.03 | 73.04 |
| Comp. Ex. 19 | Surfactant 20 | 7.02 | 20.08 | 73.01 |
| Comp. Ex. 20 | Surfactant 21 | 7 | 20.06 | 73.01 |
| Comp. Ex. 21 | Surfactant 22 | 7 | 20.03 | 73.01 |
| Comp. Ex. 22 | Surfactant 23 | 7.02 | 20.04 | 73.03 |
| Comp. Ex. 23 | Surfactant 24 | 7 | 20.02 | 73.02 |
| Comp. Ex. 24 | Surfactant 25 | 7.01 | 20.01 | 73 |
| Comp. Ex. 25 | Surfactant 26 | 7.02 | 20.02 | 73 |
| Comp. Ex. 26 | Surfactant 27 | 7.03 | 20.01 | 73.02 |
| Comp. Ex. 27 | Surfactant 28 | 7.01 | 20.00 | 73.01 |
| Comp. Ex. 28 | Surfactant 29 | 7.04 | 20.00 | 73.02 |
| Comp. Ex. 29 | Surfactant 30 | 7.04 | 20.10 | 73.02 |
| Comp. Ex. 30 | Surfactant 31 | 7.02 | 20.05 | 73.03 |
| Comp. Ex. 31 | Surfactant 32 | N/A* | — | — |
| Comp. Ex. 32 | Surfactant 33 | N/A* | — | — |
| Comp. Ex. 33 | Surfactant 34 | N/A* | — | — |
| Comp. Ex. 34 | Surfactant 35 | N/A* | — | — |
| Comp. Ex. 35 | Surfactant 36 | N/A* | — | — |
| Comp. Ex. 36 | Surfactant 37 | N/A* | — | — |
| Comp. Ex. 37 | Surfactant 38 | 7 | 20.07 | 73 |
| Comp. Ex. 38 | Surfactant 39 | N/A* | — | — |
| Comp. Ex. 39 | Surfactant 40 | 7 | 20.04 | 73.02 |
| Comp. Ex. 40 | Surfactant 41 | 7.02 | 20.00 | 73.02 |
| Comp. Ex. 41 | Surfactant 42 | 7.01 | 20.05 | 73.06 |
| Comp. Ex. 42 | Surfactant 43 | 7 | 20.06 | 73.02 |
| Comp. Ex. 43 | Surfactant 44 | 7.03 | 20.01 | 73.06 |
| Comp. Ex. 44 | Surfactant 45 | 7.02 | 20.02 | 73.01 |
| Comp. Ex. 45 | Surfactant 46 | N/A* | — | — |
| Comp. Ex. 46 | Surfactant 47 | 7.01 | 20.00 | 73 |
| Comp. Ex. 47 | Surfactant 48 | 7 | 20.04 | 73.07 |
| Comp. Ex. 48 | Surfactant 49 | 7.02 | 20.13 | 73.02 |
| Comp. Ex. 49 | Surfactant 50 | 7.01 | 20.02 | 73 |
| Comp. Ex. 50 | Surfactant 51 | 7 | 20.00 | 73.06 |
| Comp. Ex. 51 | Surfactant 52 | 7.02 | 20.00 | 73.04 |
| Comp. Ex. 52 | Surfactant 53 | 7.01 | 20.02 | 73.03 |
| Comp. Ex. 53 | Surfactant 54 | 7 | 20.01 | 73.03 |
| Comp. Ex. 54 | Surfactant 55 | 7.02 | 20.00 | 73.02 |
| Comp. Ex. 55 | Surfactant 56 | 7 | 20.02 | 73.01 |
| Comp. Ex. 56 | Surfactant 57 | 7.01 | 20.00 | 73.04 |
| Comp. Ex. 57 | Surfactant 58 | 7.01 | 20.00 | 73.03 |
| Comp. Ex. 58 | Surfactant 59 | 7.01 | 20.01 | 73.02 |
| Comp. Ex. 59 | Surfactant 60 | 7.02 | 20.11 | 73.01 |

*Data is unavailable because the components became solid or could not be mixed to form an adjuvant additive.

Surfactant 1 is a carboxylated alcohol alkoxylate commercially available under the trade name Plurafac® CS-1 (50%) from BASF Corp.

Surfactant 2 is S-MAZ® 65K commercially available from BASF Corp.

Surfactant 3 is S-MAZ® 80 commercially available from BASF Corp.

Surfactant 4 is S-MAZ® 85 SP commercially available from BASF Corp.

Surfactant 5 is S-MAZ® 90 commercially available from BASF Corp.

Surfactant 6 is Mazol® 300K commercially available from BASF Corp.

Surfactant 7 is Mazol® GMOK commercially available from BASF Corp.

Surfactant 8 is Mazol® GMSK commercially available from BASF Corp.

Surfactant 9 is Mazol® PGO 31K commercially available from BASF Corp.

Surfactant 10 is Mazol® PGO 104K commercially available from BASF Corp.

Surfactant 11 is Mazol® GMSD K commercially available from BASF Corp.

Surfactant 12 is Lutensol® XP30 commercially available from BASF Corp.

Surfactant 13 is Macol® LF 110 commercially available from BASF Corp.

Surfactant 14 is Plurafac® LF403 commercially available from BASF Corp.

Surfactant 15 is Plurafac® LF7000 commercially available from BASF Corp.

Surfactant 16 is Plurafac® RA 40 commercially available from BASF Corp.

Surfactant 17 is Pluronic® L31 commercially available from BASF Corp.

Surfactant 18 is Pluronic® L61 commercially available from BASF Corp.

Surfactant 19 is Pluronic® L62 commercially available from BASF Corp.

Surfactant 20 is Pluronic® L81 commercially available from BASF Corp.

Surfactant 21 is Pluronic® L92 commercially available from BASF Corp.

Surfactant 22 is Pluronic® L101 commercially available from BASF Corp.

Surfactant 23 is Pluronic® L121 commercially available from BASF Corp.

Surfactant 24 is Pluronic® 17R2 commercially available from BASF Corp.

Surfactant 25 is Pluronic® 25R2 commercially available from BASF Corp.

Surfactant 26 is N 7 commercially available from BASF Corp.

Surfactant 27 is N 23 P commercially available from BASF Corp.

Surfactant 28 is Mazon® 40 (as std. Per CGU) commercially available from BASF Corp.

Surfactant 29 is Pluronic® L43 commercially available from BASF Corp.

Surfactant 30 is Pluronic® L44 commercially available from BASF Corp.

Surfactant 31 is Pluronic® L64 commercially available from BASF Corp.

Surfactant 32 is Pluronic® P84 commercially available from BASF Corp.

Surfactant 33 is Pluronic® P85 commercially available from BASF Corp.

Surfactant 34 is Pluronic® P103 commercially available from BASF Corp.

Surfactant 35 is Pluronic® P104 commercially available from BASF Corp.

Surfactant 36 is Pluronic® P105 commercially available from BASF Corp.

Surfactant 37 is Pluronic® P123 commercially available from BASF Corp.

Surfactant 38 is Tetronic® 304 commercially available from BASF Corp.

Surfactant 39 is Tetronic® 904 commercially available from BASF Corp.

Surfactant 40 is Pluracare® L4370 commercially available from BASF Corp.

Surfactant 41 is T-Maz® 20 commercially available from BASF Corp.

Surfactant 42 is T-Maz® 21 commercially available from BASF Corp.

Surfactant 43 is T-Maz® 80 commercially available from BASF Corp.

Surfactant 44 is T-Maz® 85 commercially available from BASF Corp.

Surfactant 45 is T-Maz® 90 commercially available from BASF Corp.

Surfactant 46 is Pluronic® F68 commercially available from BASF Corp.

Surfactant 47 is Pluracare® L1220 commercially available from BASF Corp.

Surfactant 48 is Tetronic® 701 commercially available from BASF Corp.

Surfactant 49 is Tetronic® 901 commercially available from BASF Corp.

Surfactant 50 is Tetronic® 1301 commercially available from BASF Corp.

Surfactant 51 is Maphos® M60 commercially available from BASF Corp.

Surfactant 52 is Klearfac® AA270 commercially available from BASF Corp.

Surfactant 53 is Mapeg® 400 DO commercially available from BASF Corp.

Surfactant 54 is Inoterra® EM commercially available from BASF Corp.

Surfactant 55 is Inoterra® EMD commercially available from BASF Corp.

Surfactant 56 is Maphos® 60A commercially available from BASF Corp.

Surfactant 57 is Plurafac® D-25 commercially available from BASF Corp.

Surfactant 58 is Plurafac® SL-42 commercially available from BASF Corp.

Surfactant 59 is Plurafac® SL-62 commercially available from BASF Corp.

Surfactant 60 is Mapeg® L61 Dioleate commercially available from BASF Corp.

First Active Substance is ammonium sulfate.

Viscosity Modifier is high fructose corn syrup.

The adjuvant additives are mixed together to evaluate stability, i.e., miscibility. Each adjuvant additive is visually evaluated to determine whether particulate matter is visible in the adjuvant additive or whether separation/stratification of the adjuvant additive occurs. Adjuvant additives which do not exhibit visible particulate matter or separation/stratification are considered “soluble” while adjuvant additives which do exhibit visible particular matter and/or separation/stratification are considered “not soluble” as provided in Table 2 below.

TABLE 2

| | |
|---|---|
| Inv. Ex. 1 | soluble, clear gold colored solution |
| Comp. Ex. 1 | not soluble |
| Comp. Ex. 2 | not soluble - separated after mixing |
| Comp. Ex. 3 | not soluble - separated after mixing |
| Comp. Ex. 4 | not soluble - separated after mixing |
| Comp. Ex. 5 | not soluble - separated after mixing |
| Comp. Ex. 6 | not soluble |
| Comp. Ex. 7 | not soluble |
| Comp. Ex. 8 | not soluble - separated after mixing |
| Comp. Ex. 9 | not soluble - separated after mixing |
| Comp. Ex. 10 | not soluble |
| Comp. Ex. 11 | not soluble - separated after mixing |
| Comp. Ex. 12 | not soluble - separated after mixing |
| Comp. Ex. 13 | not soluble - separated after mixing |
| Comp. Ex. 14 | not soluble - separated after mixing |
| Comp. Ex. 15 | not soluble - separated after mixing |
| Comp. Ex. 16 | not soluble - separated after mixing |
| Comp. Ex. 17 | not soluble - separated after mixing |
| Comp. Ex. 18 | not soluble - separated after mixing |
| Comp. Ex. 19 | not soluble - separated after mixing |
| Comp. Ex. 20 | not soluble |
| Comp. Ex. 21 | not soluble - separated after mixing |
| Comp. Ex. 22 | not soluble - separated after mixing |
| Comp. Ex. 23 | not soluble - separated after mixing |
| Comp. Ex. 24 | not soluble - separated after mixing |
| Comp. Ex. 25 | not soluble - separated after mixing |
| Comp. Ex. 26 | not soluble - separated after mixing |
| Comp. Ex. 27 | soluble, dark fluid solution |
| Comp. Ex. 28 | not soluble - separated after mixing |
| Comp. Ex. 29 | not soluble - separated after mixing |
| Comp. Ex. 30 | not soluble |
| Comp. Ex. 31 | not soluble |
| Comp. Ex. 32 | not soluble |
| Comp. Ex. 33 | not soluble |
| Comp. Ex. 34 | not soluble |
| Comp. Ex. 35 | not soluble |
| Comp. Ex. 36 | not soluble |
| Comp. Ex. 37 | not soluble - separated after mixing |
| Comp. Ex. 38 | not soluble |
| Comp. Ex. 39 | not soluble - separated after mixing |
| Comp. Ex. 40 | not soluble - separated after mixing |
| Comp. Ex. 41 | not soluble - separated after mixing |
| Comp. Ex. 42 | not soluble |
| Comp. Ex. 43 | not soluble - separated after mixing |
| Comp. Ex. 44 | not soluble - separated after mixing |
| Comp. Ex. 45 | gelled, surfactant not all dissolved |
| Comp. Ex. 46 | not soluble |
| Comp. Ex. 47 | not soluble - separated after mixing |
| Comp. Ex. 48 | not soluble - separated after mixing |
| Comp. Ex. 49 | not soluble - separated after mixing |
| Comp. Ex. 50 | not soluble - separated after mixing |
| Comp. Ex. 51 | not soluble - separated after mixing |
| Comp. Ex. 52 | not soluble - separated after mixing |
| Comp. Ex. 53 | not soluble - separated after mixing |
| Comp. Ex. 54 | not soluble - separated after mixing |
| Comp. Ex. 55 | not soluble - separated after mixing |
| Comp. Ex. 56 | not soluble - separated after mixing |
| Comp. Ex. 57 | not soluble - separated after mixing |
| Comp. Ex. 58 | not soluble - separated after mixing |
| Comp. Ex. 59 | not soluble - separated after mixing |

As provided in Table 2 above, Inventive Example 1 and Comparative Example 27 are soluble, while all other Examples are not soluble using the evaluation parameters described above.

Inventive Example 1 and Comparative Example 27 are then evaluated for inhibition of foam generation using a “F-106 Persistent Foaming” method. More specifically, a 100 mL graduated cylinder is filled with 95 mL of water. A 2 gram sample of an Adjuvant Additive is then added to the graduated cylinder. The graduated cylinder is then topped off with additional water to the 100 mL line. The graduated cylinder is then stopped and inverted 180° for 30 cycles at 2 seconds per cycle. The graduated cylinder is then placed on an even surface and left undisturbed for observation. Any foam generated is measured with a ruler and checked against the cylinder to determine height and volume of foam at 10 seconds, 1 minute, 5 minutes, and 12 minutes. The results of the “F-106 Persistent Foaming” method for both Inventive Example 1 and Comparative Example 27 are provided in Table 3 below.

TABLE 3

| | |
|---|---|
| Inv. Ex. 1 | Comp. Ex. 27 |

| | | | | |
|---|---|---|---|---|
| Foam Height at 10 Sec. | 15 | mm | 50 | mm |
| Foam Height at 1 min. | 3 | mm | 45 | mm |
| Foam Height at 5 min. | 3 | mm | 45 | mm |
| Foam Height at 12 min. | 2 | mm | 42 | mm |
| Foam Volume at 10 Sec. | 8 | mL | 26 | mL |

| | | | |
|---|---|---|---|
| Foam Volume at 1 min. | 2 mL | 23 | mL |
| | (foam ring only) | | |
| Foam Volume at 5 min. | 2 mL | 23 | mL |
| | (foam ring only) | | |
| Foam Volume at 12 min. | 1 mL | 22 | mL |
| | (foam ring only) | | |

As shown in Table 3, Inventive Example 1 exhibits reduced foam generation as compared to Comparative Example 27. Additionally, the foam height and volume of Inventive Example 1 dissipate by a factor of 5 and 4, respectively, at 50 seconds after the first measurement is taken. Inventive Example 1 exhibits excellent results as compared to Comparative Example 27 which exhibits significant foam generation. Also, the foam of Comparative Example 27 fails to dissipate at a satisfactory rate.

Inventive Examples A-D and Comparative Examples A-C were then prepared using the same surfactant included in Inventive Example 1 (Surfactant 1) as set forth in Table 4 below, with all amounts listed as percent by weight based on the total weight of the respective adjuvant additives.

TABLE 4

| | Inv. Ex. A | Inv. Ex. B | Inv. Ex. C | Inv. Ex. D |
|---|---|---|---|---|
| First Active | 26 | 26 | 26 | 26 |
| Substance | | | | |
| Surfactant 1 | 16 | 18 | 20 | 20 |
| Water | 38 | 36 | 34 | 54 |
| Viscosity | 20 | 20 | 20 | 0 |
| Modifier | | | | |

| | Comp. Ex. A | Comp. Ex. B | Comp. Ex. C |
|---|---|---|---|
| First Active | 30 | 30 | 30 |
| Substance | | | |
| Surfactant 1 | 14 | 16 | 18 |
| Water | 36 | 34 | 32 |
| Viscosity | 20 | 20 | 20 |
| Modifier | | | |

First Active Substance is ammonium sulfate.

Surfactant 1 is a carboxylated alcohol alkoxylate commercially available under the trade name Plurafac® CS-1 from BASF Corp.

Viscosity Modifier is high fructose corn syrup.

Inventive Examples A-D and Comparative Examples A-C are then left undisturbed at approximately 20° C. and periodically evaluated for stability as described above. Examples which do not exhibit visible particulate matter or separation/stratification are considered stable, while Examples which do exhibit visible particular matter and/or separation/stratification are considered unstable as provided in Table 5 below.

TABLE 5

| | |
|---|---|
| Inv. Ex. A | homogenous and clear after |
| | mixing, separation after 9 days |
| Inv. Ex. B | homogenous and clear after |
| | mixing, separation after 10 days |
| Inv. Ex. C | homogenous and clear after |
| | mixing, separation after 10-12 days |
| Inv. Ex. D | clear after mixing, separation after |
| | 24 days |
| Comp. Ex. A | emulsion like appearance, |
| | complete separation after 24 hours |
| Comp. Ex. B | hazy appearance, complete |
| | separation after 24 hours |
| Comp. Ex. C | hazy appearance, complete |
| | separation after 24 hours |

As shown in Table 5, Inventive Example A-D exhibited excellent stability over time as compared to Comparative Examples A-C which separated after 24 hours.

Additional adjuvant additives, including Inventive Examples E-H and Comparative Example D, are prepared using a reduced amount of the same surfactant included in Inventive Example 1 (Surfactant 1), as set forth in Table 6 below, with all amounts listed as percent by weight based on the total weight of the respective adjuvant additives. The First Active Substance and the Viscosity Modifier are the same.

TABLE 6

| | Inv. | Inv. | Inv. | Inv. | Comp. |
|---|---|---|---|---|---|
| | Ex. E | Ex. F | Ex. G | Ex. H | Ex. D |
| First Active | 26 | 26 | 26 | 26 | 26 |
| Substance | | | | | |
| Surfactant 1 | 14 | 14 | 14 | 14 | 14 |
| Water | 40 | 40 | 40 | 40 | 40 |
| Viscosity | 20 | 20 | 20 | 20 | 20 |
| Modifier | | | | | |

Inventive Examples E-H and Comparative Example D are then left undisturbed at approximately 20° C. and periodically evaluated for stability as described above. When separation of Inventive Examples E-H occurs, the Examples are pH buffered with 0.66 N NaOH as detailed in Table 7 below.

TABLE 7

| | Inv. Ex. E | Inv. Ex. F | Inv. Ex. G | Inv. Ex. H |
|---|---|---|---|---|
| Starting pH | 6.88 | 6.95 | 6.96 | 6.93 |
| Separation pre | 3 days | 7 days | 6 days | 7 days |
| buffering | | | | |
| pH After | 6.67 | 6.69 | 6.68 | 6.7 |
| Separation | | | | |
| Buffered to | 7.96 | 7.95 | 8.00 | 7.94 |
| after separation | | | | |
| Separation post | 17 days | 17 days | 17 days | 17 days |
| buffering | | | | |

Even though Inventive Examples E-H include a reduced amount of Surfactant 1 as compared to Inventive Examples A-D, each of Example E-H exhibits satisfactory stability. Additionally, after pH buffering, each of Inventive Examples E-H returns to stable homogenous mixtures after light agitation without separation for an additional 17 days.

An agrochemical composition is prepared using the adjuvant additive of Inventive Example B above. More specifically, the adjuvant additive, a second active substance, and water are included in the agrochemical composition, as set forth in Table 8 below, with all amounts listed as percent by weight based on the total weight of the agrochemical composition.

TABLE 8

| | Inv. Agro. |
|---|---|
| | Comp. 1 |
| Inv. Ex. B | 2 |
| (adj. additive) | |
| Second Active | 7 |
| Substance | |
| Water | 91 |

Second Active Substance is glyphosate.

Water is standard hard water (342 ppm).

The agrochemical composition described in Table 8 above, was left undisturbed at approximately 20° C. and periodically evaluated for stability as described. The agrochemical composition remained clear and homogenous for greater than 60 days, exhibiting excellent stability.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

1. An adjuvant additive for an agrochemical composition, said adjuvant additive comprising:
A) a first active substance;
B) water; and
C) a surfactant comprising a carboxylated alcohol alkoxylate of the general formula (I): 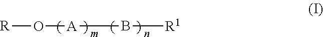
wherein R is hydrocarbon group having from 4 to 14 carbon atoms; R¹ is selected from the group of a hydrogen atom, an alkyl group, and an aryl group; each A is independently selected from an alkyleneoxy group having from 2 to 4 carbon atoms; m has a value of from 20 to 35; and each B is independently of the general formula (II): 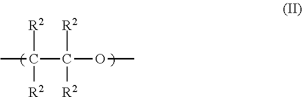
wherein each R² is independently selected from the group of a hydrogen atom, an alkyl group, and a salt of a carboxyl group, and n has a value of from 6 to 20; and
wherein at least one R² is a salt of a carboxyl group.

2. An adjuvant additive as set forth in claim 1 wherein said first active substance is present in an amount of greater than 10 and less than 30% by weight based on the total weight of said adjuvant additive.

3. An adjuvant additive as set forth in claim 1 wherein said first active substance is a nitrogenous fertilizer selected from the group of ammonia solutions, ammonium salts, urea, thiourea, and combinations thereof.

4. An adjuvant additive as set forth in claim 3 wherein said nitrogenous fertilizer is ammonium sulfate.

5. An adjuvant additive as set forth in claim 1 wherein said carboxylated alcohol alkoxylate is present in an amount of from 1 to 20% by weight based on the total weight of said adjuvant additive.

6. An adjuvant additive as set forth in claim 1 wherein said salt of said carboxyl group is further defined as a salt of a dicarboxylic group.

7. An adjuvant additive as set forth in claim 1 wherein said carboxylated alcohol alkoxylate is of the general formula (III): 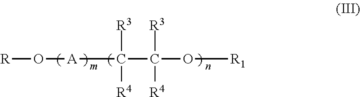
wherein R, R¹, A, m, and n are the same as defined above; each R³ is independently selected from the group of a hydrogen atom and a methyl group; and each R⁴ is independently selected from the group of a hydrogen atom and a salt of a dicarboxylic group of the general formula (IV): 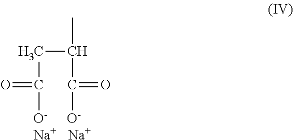
wherein at least one R⁴ is represented by a salt of a dicarboxylic group of the general formula (IV).

8. An adjuvant additive as set forth in claim 1 wherein m is of from 24 to 28 and n is of from 6 to 10.

9. An adjuvant additive as set forth in claim 1 further comprising a viscosity modifier selected from the group of high fructose corn syrup and honey and present in an amount of from 10 to 30% by weight based on the total weight of said adjuvant additive.

10. An adjuvant additive as set forth in claim 1 further comprising a pH buffer selected from the group of NaOH, KOH, and NH₄OH.

11. An adjuvant additive as set forth in claim 1 that has a foam height of less than or equal to 20 mm measured at 10 seconds in accordance with F-106 Persistent Foaming Method.

12. An adjuvant additive as set forth in claim 1 that remains homogenous at a temperature of 20° Celsius for a period of at least 3 days.

13. An agrochemical composition for treating plants, said agrochemical composition comprising:
i) an adjuvant additive comprising;
A) a first active substance,
B) water, and
C) a surfactant comprising a carboxylated alcohol alkoxylate of the general formula (I): 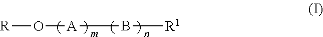
wherein R is hydrocarbon group having from 4 to 14 carbon atoms; R¹ is selected from the group of a hydrogen atom, an alkyl group, and an aryl group; each A is independently selected from an alkyleneoxy group having from 2 to 4 carbon atoms; m has a value of from 20 to 35; and each B is independently of the general formula (II): 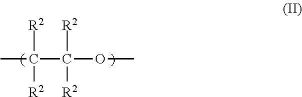
wherein each R² is independently selected from the group of a hydrogen atom, an alkyl group, and a salt of a carboxyl group, and n has a value of from 6 to 20; and
wherein at least one R² is a salt of a carboxyl group; and
ii) a second active substance different from said first active substance.

14. An agrochemical composition as set forth in claim 13 wherein said second active substance is selected from the group of acetyl-CoA carboxylase inhibitors, acetolactate synthase inhibitors, amides, auxin herbicides, auxin transport inhibitors, carotinoid biosynthesis inhibitors, enolpyruvylshikimate-3-phosphate synthase inhibitors, glutamine synthetase inhibitors, lipid biosynthesis inhibitors, mitosis inhibitors, protoporphyrinogen IX oxidase inhibitors, photosynthesis inhibitors, synergists, growth substances, cell wall synthesis inhibitors, and combinations thereof.

15. An agrochemical composition as set forth in claim 13 wherein said adjuvant additive is present in an amount of greater than 0 but less than 10% by weight based on the total weight of said agrochemical composition.

16. An agrochemical composition as set forth in claim 13 wherein said first active substance is a nitrogenous fertilizer selected from the group of ammonia solutions, ammonium salts, urea, thiourea, and combinations thereof, and is present in an amount of greater than 10 and less than 30% by weight based on the total weight of said adjuvant additive.

17. An agrochemical composition as set forth in claim 13 wherein said carboxylated alcohol alkoxylate is present in an amount of from 1 to 20% by weight based on the total weight of said adjuvant additive.

18. An agrochemical composition as set forth in claim 13 wherein said carboxylated alcohol alkoxylate is of the general formula (III): 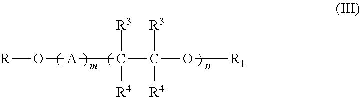
wherein R, R¹, A, m, and n are the same as defined above; each R³ is independently selected from the group of a hydrogen atom and a methyl group; and each R⁴ is independently selected from the group of a hydrogen atom and a salt of a dicarboxylic group of the general formula (IV): 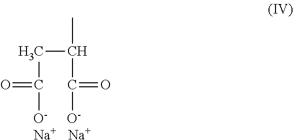
wherein at least one R⁴ is represented by a salt of a dicarboxylic group of the general formula (IV).

19. An agrochemical composition as set forth in claim 13 wherein m is of from 24 to 28 and n is of from 6 to 10.

20. An agrochemical composition as set forth in claim 13 that remains homogenous at a temperature of 20° Celsius for a period of at least 3 days.
